(19) United States
(12) Patent Application Publication
(10) Pub. No.: US 2006/0089133 A1
(43) Pub. Date: Apr. 27, 2006

(54) Communication device, address search device, address acquisition method, authentication method, communication disconnection method, and address search method

(76) Inventors: Fumio Yoshizawa, Tokyo (JP); Akira Murakata, Tokyo (JP); Hiroaki Fukuda, Tokyo (JP); Shuji Kimura, Tokyo (JP); Atsushi Togami, Tokyo (JP); Yasunobu Shirata, Tokyo (JP); Isao Miyamoto, Tokyo (JP); Satoshi Ohkawa, Tokyo (JP); Hiroyuki Kawamoto, Tokyo (JP)

Correspondence Address: HARNESS, DICKEY & PIERCE, P.L.C., P.O. BOX 8910, RESTON, VA, 20195, US

(21) Appl. No.: 11/227,430

(22) Filed: Sep. 16, 2005

(30) Foreign Application Priority Data
Sep. 17, 2004 (JP) 2004-270848
Aug. 18, 2005 (JP) 2005-237439

(51) Int. Cl. H04M 3/00

(52) U.S. Cl. 455/418; 455/411

(57) ABSTRACT

A search device communicates with a first device and a second device through a network. The search device includes a storage unit that stores therein a first telephone number of the first device, a second telephone number of the second device, and a first communication address of the first device in an associated manner; a receiving unit that receives, from the second device, a third telephone number of the first device, a fourth telephone number of the second device, and a second communication address of the second device; an extracting unit that extracts, from the storage unit, a first communication address that corresponds to the third telephone number and the fourth telephone number; and a transmitting unit that transmits extracted first communication address to the second device.

### CROSS-REFERENCE TO RELATED APPLICATIONS

The present document incorporates by reference the entire contents of Japanese priority document, 2004-270848 filed in Japan on Sep. 17, 2004, and 2005-237439 filed in Japan on Aug. 18, 2005.

### BACKGROUND OF THE INVENTION

1. Field of the Invention

The present invention relates to a technology for communicating electronic data between communication devices that communicate with each other through a network.

2. Description of the Related Art

Telephones are the most popular means to communicate information. However, the telephone only enables speech communication. Therefore, the telephone does not satisfy such a demand of a user that a paper document can be exchanged with the other party during a telephone conversation so that the conversation is more understandable.

For example, it is desired that a pamphlet be immediately provided to a client while a salesperson is discussing business with the client on the telephone. This is because a copy of the pamphlet helps the client more accurately understand the information that the salesperson wants to tell rather than reading out the content of the pamphlet through the telephone.

Furthermore, there are many cases where a conference material, which is not prepared to be released, happens to be released as answers to questions during a telephone conference. In these cases, it is desired that the conference material be immediately distributed to participants of the telephone conference so that the participants can share the information in the conference material while discussing an issue.

A technology that can be useful in these cases is disclosed in Japanese Patent Application Laid-Open No. 2000-69133. In this technology, to easily transmit a document, a facsimile on the side of accepting a document acquires a telephone number of a destination facsimile based on transmitting subscriber identification (TSI) to register the telephone number acquired in a telephone-number registration table. This enables a user to easily register a telephone number of a destination facsimile and use the telephone number.

In the conventional technology, however, although it is useful when the same facsimile is regularly used, for example, in an office, when a user is out of the office, telephone numbers of facsimiles have to be newly entered.

Technologies called internet protocol version 6 (IpV6) and universal plug and play (UPnP) have been proposed in 1990's, and they are being developed even now. It is said that when these technologies are widely used, all devices connected to an internet protocol (IP) network recognize each other so that information is exchanged among the devices. Image processors are also included in such devices. Therefore, it is predicted that all the image processors can mutually recognize each other so that image information can be exchanged in an end-to-end manner. For example, an application called “copy machine-to-copy machine” function can be created. This application is such that an image read by a scanner of a copy machine is printed in real time by a printer of a copy machine that is remotely located.

For realization of the “copy machine-to-copy machine” function, the process to determine a destination largely affects achieving the ease-of-use. In the case of the facsimile, a communication destination is determined by a sender of a document entering a telephone number of a destination facsimile. In a case of the “copy machine-to-copy machine” function, a communication destination is determined by a sender of a document entering an IP address and a media access control (MAC) address of a destination facsimile or entering a proper name from which an address thereof can be solved.

The method of entering a communication destination in the “copy machine-to-copy machine” function, which is about to be realized on the IP network, requires entry of an IP address and a MAC address, or a unique character/number string from which a relevant address can be solved. Such an operation is complicated for a user and mistakable. Moreover, if an address such as the IP address, by which an image processor can be identified, is disclosed, a document may be sent unilaterally from an unknown person. Consequently, it is an inevitable result that the communication destination is mistaken by the miss operation or that the document is unilaterally distributed by an unidentified person. Therefore, this technique is not always suitable for the “copy machine-to-copy machine” function.

### SUMMARY OF THE INVENTION

It is an object of the present invention to at least solve the problems in the conventional technology.

A search device according to one aspect of the present invention communicates with a first device and a second device through a network. The search device includes a storage unit configured to store therein a first telephone number of the first device, a second telephone number of the second device, and a first communication address of the first device in an associated manner; a receiving unit configured to receive, from the second device, a third telephone number of the first device, a fourth telephone number of the second device, and a second communication address of the second device; an extracting unit configured to extract, from the storage unit, a first communication address that corresponds to the third telephone number and the fourth telephone number; and a transmitting unit configured to transmit extracted first communication address to the second device.

A communication device according to another aspect of the present invention includes a number acquiring unit configured to acquire a telephone number of the communication device and a telephone number of a second communication device to which the communication device is to transmit electronic data through a network; and an address acquiring unit configured to acquire a communication address of the second communication device based on acquired telephone numbers and a communication address of the communication device.

A communication device according to still another aspect of the present invention includes an authentication-information acquiring unit configured to acquire authentication information that is arbitrarily determined by users; an authentication-information receiving unit configured to receive authentication information transmitted from a second communication device; a determining unit configured to determine whether received authentication information corresponds with acquired authentication information; and a transmitting unit configured to transmit electronic data to the second communication device when the determining unit determines that the received authentication information corresponds with the acquired authentication information.

A communication device according to still another aspect of the present invention includes an authentication-information acquiring unit configured to acquire authentication information that is arbitrarily determined by users; an authentication-information receiving unit configured to receive authentication information transmitted from a second communication device; a determining unit configured to determine whether received authentication information corresponds with acquired authentication information; and a disconnecting unit configured to disconnect communication between the communication device and the second communication device after a specific time has elapsed, when the determining unit determines that the received authentication information corresponds with the acquired authentication information.

A search method according to still another aspect of the present invention is performed by a search device that includes a storage unit and that is configured to communicate with a first device and a second device through a network. The search method includes storing, in the storage unit, a first telephone number of the first device, a second telephone number of the second device, and a first communication address of the first device in an associated manner; receiving, from the second device, a third telephone number of the first device, a fourth telephone number of the second device, and a second communication address of the second device; extracting, from the storage unit, a first communication address that corresponds to the third telephone number and the fourth telephone number; and transmitting extracted first communication address to the second device.

An acquisition method of acquiring a communication address according to still another aspect of the present invention includes acquiring a telephone number of a first communication device and a telephone number of a second communication device to which the first communication device is to transmit electronic data through a network; and acquiring a communication address of the second communication device based on acquired telephone numbers and a communication address of the first communication device.

A authentication method according to still another aspect of the present invention is for authenticating users of a first communication device and a second communication device that communicate with each other through a network. The authentication method includes acquiring authentication information that is arbitrarily determined by users; receiving authentication information transmitted from the second communication device; and determining whether received authentication information corresponds with acquired authentication information. The first communication device transmits electronic data to the second communication device when it is determined that the received authentication information corresponds with the acquired authentication information at the determining.

A disconnection method according to still another aspect of the present invention is for disconnecting communication between a first communication device and a second communication device. The disconnection method includes acquiring authentication information that is arbitrarily determined by users; receiving authentication information transmitted from the second communication device; determining whether received authentication information corresponds with acquired authentication information; and disconnecting the communication after a specific time has elapsed, when it is determined that the received authentication information corresponds with the acquired authentication information at the determining.

A computer-readable recording medium according to still another aspect of the present invention stores therein a computer program for realizing a search method according to the above aspect.

A computer-readable recording medium according to still another aspect of the present invention stores therein a computer program for realizing an acquisition method according to the above aspect.

A computer-readable recording medium according to still another aspect of the present invention stores therein a computer program for realizing an authentication method according to the above aspect.

A computer-readable recording medium according to still another aspect of the present invention stores therein a computer program for realizing a disconnection method according to the above aspect.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a copy machine according to a first embodiment of the present invention;

FIG. 2 is a block diagram of a server connected to the copy machine via a network;

FIG. 3 is a schematic for illustrating a setting screen for read conditions displayed on a liquid-crystal touch panel;

FIG. 4 is a schematic for illustrating a setting screen for print conditions displayed on the liquid-crystal touch panel;

FIG. 5 is a schematic for illustrating an entry screen displayed on the liquid-crystal touch panel;

FIG. 6 is a schematic for illustrating an entry screen for prompting entry from a telephone set;

FIG. 7A and FIG. 7B are flowcharts of find processes;

FIG. 8 is a schematic for illustrating a data transmission/reception system according to the first embodiment;

FIG. 9 is a flowchart of a procedure of compare processes;

FIG. 10 is a schematic for illustrating an entry screen for entering a password displayed on the liquid-crystal touch panel;

FIG. 11 is a flowchart of a procedure of a negotiation process;

FIG. 12A and FIG. 12B are flowcharts of disconnection processes;

FIG. 13 is a schematic for illustrating a data transmission/reception system according to a second embodiment of the present invention; and

FIG. 14 is a schematic for illustrating a hardware configuration of the server according to the embodiments.

### DETAILED DESCRIPTION OF THE PREFERRED EMBODIMENTS

Exemplary embodiments according to the present invention are explained in detail below with reference to the accompanying drawings. In the embodiments, a communication device is a copy machine, and a data transmission/reception system includes telephone sets, through which a user and a called party communicate, copy machines that transmit and receive an image, and a server that searches for a communication address of each copy machine. The communication address is used for communication between the copy machines. In the embodiments, users of the data transmission/reception system, in which the “copy machine-to-copy machine” function is implemented on an IP network, are ready to communicate with each other on the telephone (during a telephone connection) with a communication tool, such as a fixed-line phone and a cell phone. When a copy machine transmits or receives image information, a server identifies communication addresses of both the copy machines of the user and the called party, from a telephone number of a telephone used by the user and from a telephone number of a telephone as a called party (as an example of entering telephone numbers of the user's telephone and the called party's telephone, there is a method of acquiring incoming and outgoing information by a telephone set interface unit). The following case is explained below. The case is such that copy machines are connected to each other by identifying the communication addresses of the copy machines, to transmit image information input through a scanner or the like.

In the following, there is shown an example of making the “copy machine-to-copy machine” possible. However, the communication device that constitutes the data transmission/reception system may be any device capable of capturing image information, printing out, and transmitting or receiving an image to or from a network, for example, a scanner, a network printer, or an information processing terminal such as a personal computer (PC) that is connected with a scanner and a printer. The network can be a wired or a wireless network.

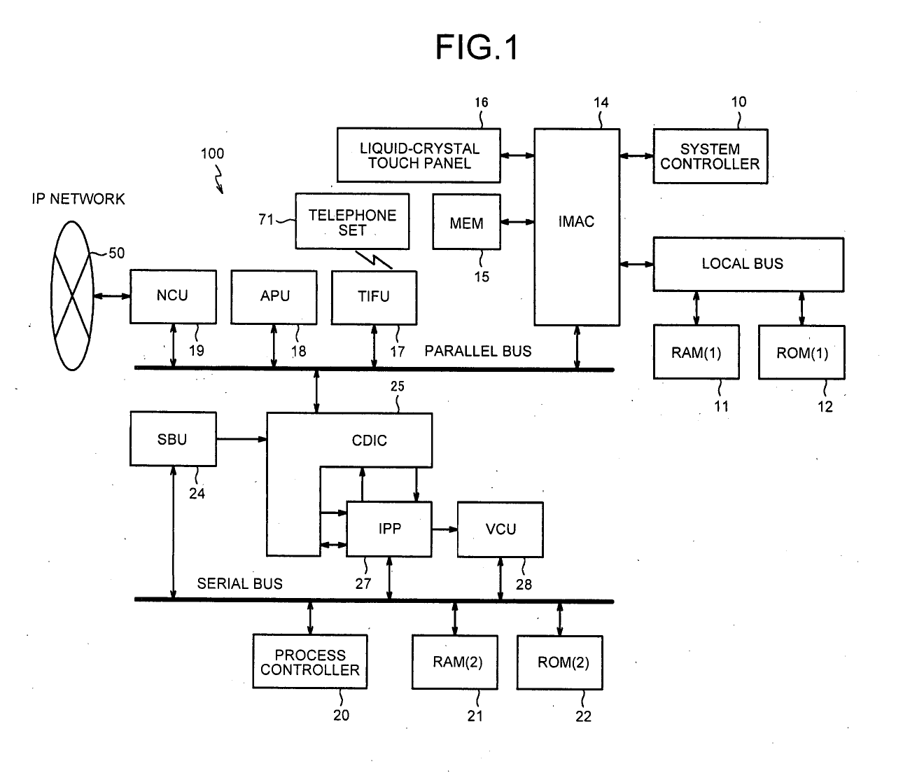

FIG. 1 is a block diagram of a copy machine according to the first embodiment. While the copy machine is explained as an example of the communication device in the first embodiment, a scanner, a printer, a multifunction peripheral, and a PC connected with a printer and a scanner may be used, instead of the copy machine. Referring to FIG. 1, a sensor board unit (SBU) 24 optically reads a document, where light irradiated from a light source illuminates the document, and the light reflected thereby is collected to a light receiving element. The light receiving element converts the intensity of the light collected to an analog electrical signal, and a charge-coupled device (CCD) is used as the device in this example. The analog electrical signal output from the CCD is quantized and is output as digital image data from the SBU 24.

An image processing processor (IPP) 27 performs image processing on the digital image data. This unit optimizes frequency characteristics and gradation characteristics of the digital image data according to conditions set by a user and device characteristics specific to the machine.

A communication controller (compression/decompression data interface controller: CDIC) 25 helps smooth transmission or reception of the digital image data performed between the units. The SBU 24 and the IPP 27 perform transmission and reception of the digital image data, always through the CDIC 25.

An image memory access controller (IMAC) 14 converts a format of the digital image data to access a memory (MEM) 15. The MEM 15 stores the digital image data and temporarily accumulates an image read by the SBU 24 and an image sent from an information processing terminal such as another copy machine and a PC through an IP network 50. The MEM 15 further stores a comparison result as to whether a password entered through a liquid-crystal touch panel 16 and a password transmitted from a copy machine as a called party match each other.

A network control unit (NCU) 19 performs transmission or reception of the digital data to or from another copy machine and a PC, which are connected to the IP network 50. Upon transmission, the NCU 19 processes the data according to a communication protocol of the IP network 50, and outputs the data processed to the IP network 50. Upon reception, the NCU 19 reproduces original reception data from the data processed according to the communication protocol. Further, the NCU 19 can receive an IP address of a copy machine as a called party.

The NCU 19 transmits a user's telephone number, a called party's telephone number obtained from a telephone interface unit (TIFU) 17 or from the liquid-crystal touch panel 16, and an IP address stored in read only memory (ROM (1)) 12, to a server 200. The user's telephone number is a telephone number of a telephone set 71 (as a representative of 71a, 71b, and 71c), through which a user using a copy machine 100 (as a representative of 100a, 100b, and 100c) is in conversation with a called party. That is, the user's telephone number is user's identification information for identifying a user. The called party's telephone number is a telephone number of the telephone set 71 as the called party, that is, the called party's telephone number is other party's identification information for identifying the other party. The IP address is used for identifying the copy machine 100 in the IP network. While the case where the IP address is used as a communication address is explained in the first embodiment, an MAC address, an E-mail address, and a specific character/number string, from which a relevant address can be solved, may be used instead of the IP address.

The NCU 19 receives a password of the other party transmitted from the copy machine 100 used by the other party.

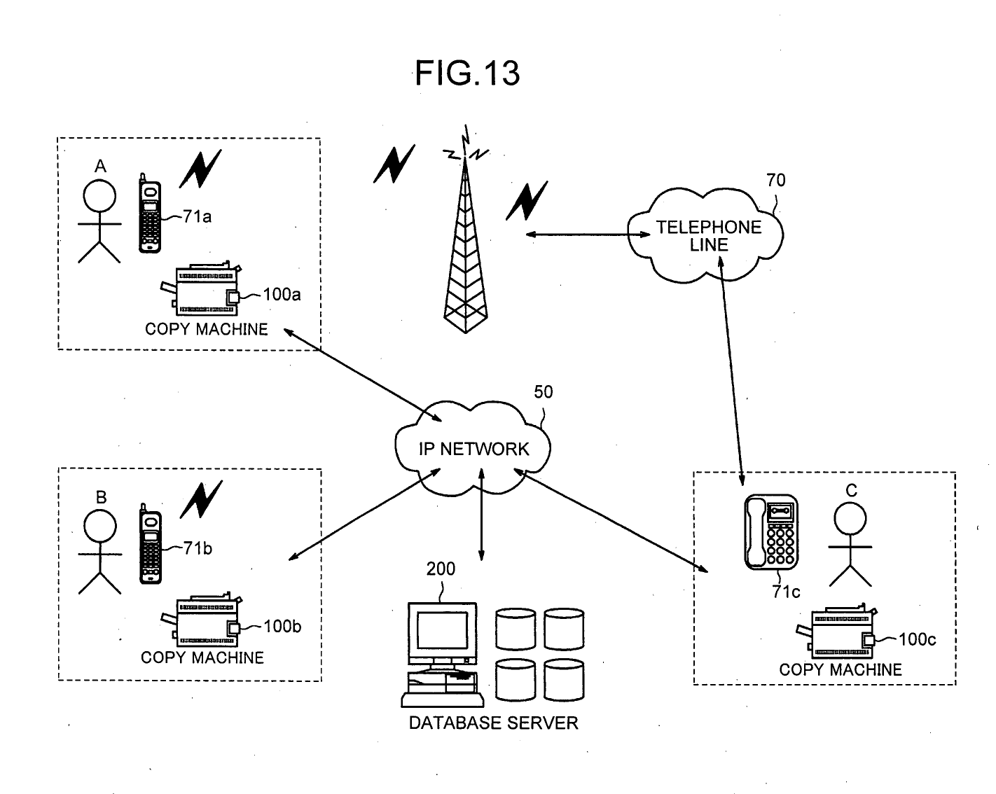

The TIFU 17 performs transmission or reception of the digital data to or from a telephone set 71 (see FIG. 13) used by the user of the copy machine 100 for making a call. The TIFU 17 mainly acquires information on a call such as a user's telephone number (called party's telephone number), and outgoing and incoming calls.

A wireless short-distance communication standard (e.g., radio frequency identification (RFID) and Bluetooth) is preferably employed for communication between the copy machine 100 and the telephone set 71. Employment of this standard has some advantages such that there is no need to connect between the two with a communication cable or the like, which does not restrict a telephone calling environment. Moreover, in the case of short-distance communication, a cross talk with another telephone set is possibly avoided. Recently, a plurality of companies and organizations try mounting a function of electronic money or electronic ticket on cell phones. As a method of acquiring money information or ticket information from the cell phone, the standard of wireless short-distance communication is employed. Therefore, there is a large possibility, in the near future, that telephone sets with a built-in interface for the wireless short-distance communication are distributed in the market, and hence, employment of this method is highly convenient.

The telephone set 71 holds a telephone number of the relevant telephone set (or a first telephone set) 71, and acquires a telephone number of a telephone set as a called party (or a second telephone set) that is in telephone connection, from the second telephone set using an other party's number notifying function. When having received a signal from the TIFU 17 of the copy machine 100, the first telephone set 71 transmits the telephone number of the first telephone set 71 and the telephone number of the second telephone set.

A video control unit (VCU) 28 reproduces an image on a sheet of paper. The VCU 28 determines a position, a size, and a color of dots to be printed on the sheet, from digital image data received from the IPP 27, and prints the dots by a plotter, to reproduce the image on the sheet.

An auto payment unit (APU) 18 collects a fee for use of the copy machine 100 from a user. The APU 18 has a slot for a bill and a coin, and a tray for change, so that the user can pay for it in advance. Collecting is carried out each time the fee occurs, and if there is the balance after all the operations are finished, part of payment is returned as change. Further, the APU 18 charges based on a set charging rate. The APU 18 can employ the way to collect a fee at an arbitrary rate from both sides or one side of the copy machine 100 used by the user and the copy machine 100 used by the other party.

The liquid-crystal touch panel 16 displays information (display of guidance of operations or so) required for the user to use the copy machine 100, and its display screen is touched by the user, thereby allowing the user to perform a setting operation.

The liquid-crystal touch panel 16 accepts an input of a charging rate for transmission of image data on the user and the called party. The liquid-crystal touch panel 16 also accepts an input whether to transmit image information to the other party.

A process controller 20 controls the operations of the SBU 24, the CDIC 25, the IPP 27, and the VCU 28. Therefore, the process controller 20 sets respectively required operation conditions, and monitors how each component is started, ended, and how respective processes are progressing.

A system controller 10 controls the operations of the IMAC 14, the NCU 19, the MEM 15, the liquid-crystal touch panel 16, the TIFU 17, and the APU 18. Therefore, the system controller 10 sets respectively required operation conditions, and monitors how each component is started, ended, and how respective processes are progressing.

Further, the system controller 10 compares the user's password entered through the liquid-crystal touch panel 16 with the other party's password transmitted from the copy machine of the other party, to determine whether there is a match. When a predetermined time has elapsed from the time when “match” has been stored in the MEM 15 as the result of comparison, the system controller 10 stores “non-match” as the result of comparison in the MEM 15. When a predetermined time has elapsed from the time when “non-match” has been stored in the MEM 15 as the result of comparison and it is determined that the passwords do not match as the comparison process of the passwords, the system controller 10 instructs to disconnect the communication line.

The RAM(1) 11 and read only memory (ROM)(1) 12 connected to the IMAC 14 through a local bus store information required for processes performed by the system controller 10, the IMAC 14, the liquid-crystal touch panel 16, the MEM 15, the NCU 19, the TIFU 17, and the APU 18. The information includes, for example, text information and bitmap information for displaying a character and a pattern on the liquid-crystal touch panel 16, a total amount and a remaining amount of the digital image data that can be accumulated in the MEM 15, protocol information for making access from the NCU 19 to an information processing terminal, and information entered by a user through the liquid-crystal touch panel 16. When a processor is installed in those such as the IMAC 14, the liquid-crystal touch panel 16, the MEM 15, the NCU 19, the TIFU 17, the APU 18, and the system controller 10, a program that describes each operation is also stored in the ROM(1) 12. The IP address of the copy machine according to the first embodiment is further stored therein.

RAM(2) 21 and ROM(2) 22 connected to a serial bus store information required for processes performed by the SBU 24, the CDIC 25, the IPP 27, the VCU 28, and the process controller 20. The information includes, for example, the size of an image to be read by the SBU 24, optical characteristics of the CCD, and parameters for image processing executed by the IPP 27. When a processor is installed in those in the SBU 24, the CDIC 25, the IPP 27, the VCU 28, and the process controller 20, a program that describes each operation is also stored in the ROM(2) 22.

A printing unit (not shown) outputs image information transmitted from a copy machine of a called party.

A transmission/reception-address setting program, an authentication-information comparison program, and a communication-line disconnection program are executed by the copy machine 100 according to the first embodiment, and they are preinstalled in the ROM(1) 12 or the ROM(2) 22, and are provided.

The transmission/reception-address setting program, the authentication-information comparison program, and the communication-line disconnection program may also be provided by being recorded in a computer-readable recording medium such as a compact disk (CD)-ROM, a flexible disk (FD), a CD-recordable (R), and a digital versatile disk (DVD) with a file in an installable form or an executable form.

An address inquiry program, the authentication-information comparison program, the communication-line disconnection program executed by the copy machine 100 may be provided by being stored in a computer connected to a network such as the Internet and being downloaded through the network. Furthermore, the transmission/reception-address setting program, the authentication-information comparison program, and the communication-line disconnection program may be provided or distributed through the network.

The address inquiry program, the authentication-information comparison program, the communication-line disconnection program allow the computer to realize each unit (such as an identification-information acquiring unit, a user-information transmitting unit, a user-information receiving unit, an authentication-information acquiring unit, an authentication-information receiving unit, an authentication-information comparing unit, an image-information transmitting unit, a comparison-result invalidating unit, and a communication-line disconnecting unit).

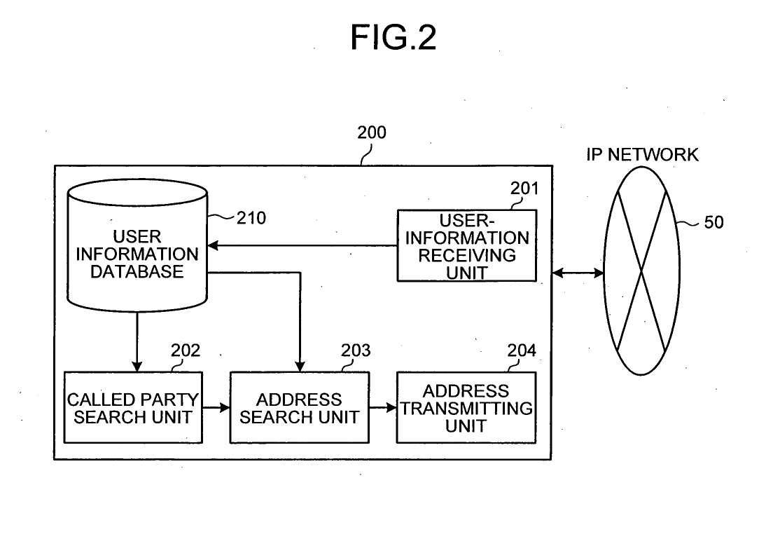

FIG. 2 is a block diagram of a server connected to the copy machine via the IP network 50. Instead of the IP network 50, any one of networks such as a local area network (LAN) and a radio communication network may be used. The server 200 includes a user-information receiving unit 201, a called party search unit 202, an address search unit 203, an address transmitting unit 204, and a user information database 210. The server 200 constitutes the search device for addresses according to the present invention.

The user-information receiving unit 201 receives a user's telephone number and a called party's telephone number, and an IP address of the copy machine 100 used by a user, which are transmitted from the copy machine 100. The called party search unit 202 searches for and acquires user information transmitted from a copy machine as the other party, from the user information database 210 based on the called party's telephone number and the user's telephone number received.

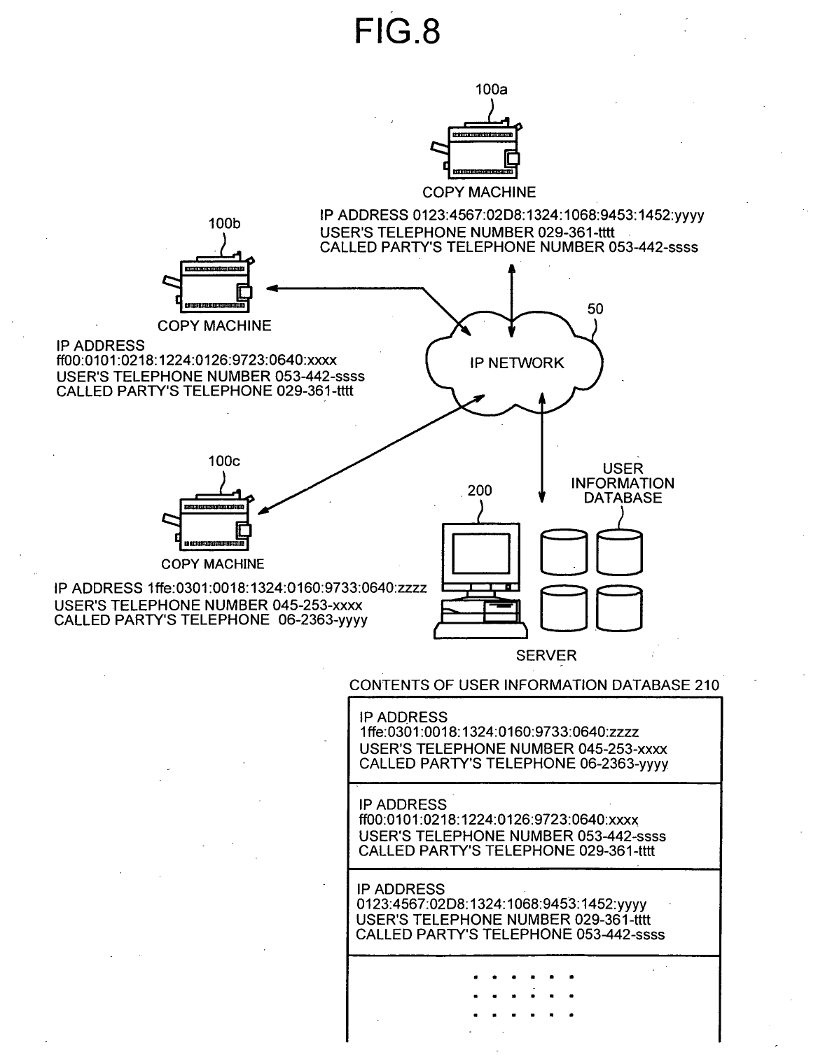

The address search unit 203 searches for an IP address of the copy machine 100 used by the called party, from the user information for the called party acquired by the called party search unit 202. The address transmitting unit 204 transmits the IP address of the copy machine 100 of the other party. The user information database 210 stores the user's telephone number, the called party's telephone number, and the IP address used by the user, which are received by the user-information receiving unit 201, in such a manner that these are associated to one another as user information. An example of the contents of the user information database 210 is shown in FIG. 8.

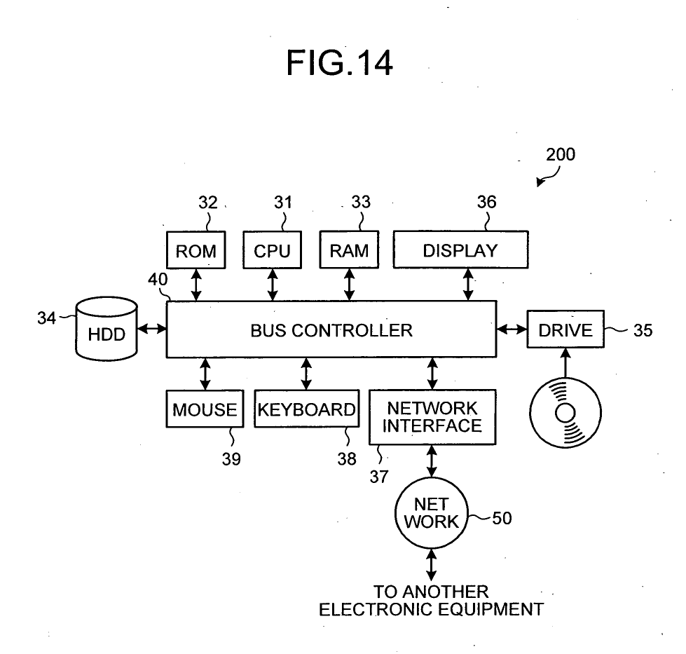

FIG. 14 is a schematic for illustrating a hardware configuration of the server 200 according to the embodiments. The server 200 includes a controller such as a central processing unit (CPU) 31, a storage device such as ROM 32 and RAM 33, an external storage device such as a hard disk drive (HDD) 34 and a CD drive 35, a display device such as a display unit 36, and an input device such as a keyboard 38 and a mouse 39. These components communicate with one another through a bus controller 40, and are connected to the IP network 50 through a network interface 37, to configure ordinary hardware using a computer.

An address search program executed by the server 200 can be recorded in a computer-readable recording medium such as a CD-ROM, an FD, a CD-R, and a DVD with a file in an installable form or an executable form. The address search program may also be preinstalled in the built-in ROM or the like, and provided.

The address search program executed by the server 200 may be provided by being stored in a computer connected to the IP network 50 and being downloaded through the IP network 50. Furthermore, the address search program executed by the server 200 may be provided or distributed through the network such as the Internet.

The address search program executed by the server 200 allows the computer to realize each unit (such as the user-information receiving unit, the called party search unit, the address search unit, and the address transmitting unit).

Specific operations of respective basic operations performed by the copy machine 100 are explained below. The basic operations include “scan to memory operation”, “memory to print operation”, “memory to network operation”, “network to memory operation”, “find operation”, “compare operation”, “negotiation operation”, and “disconnect operation”.

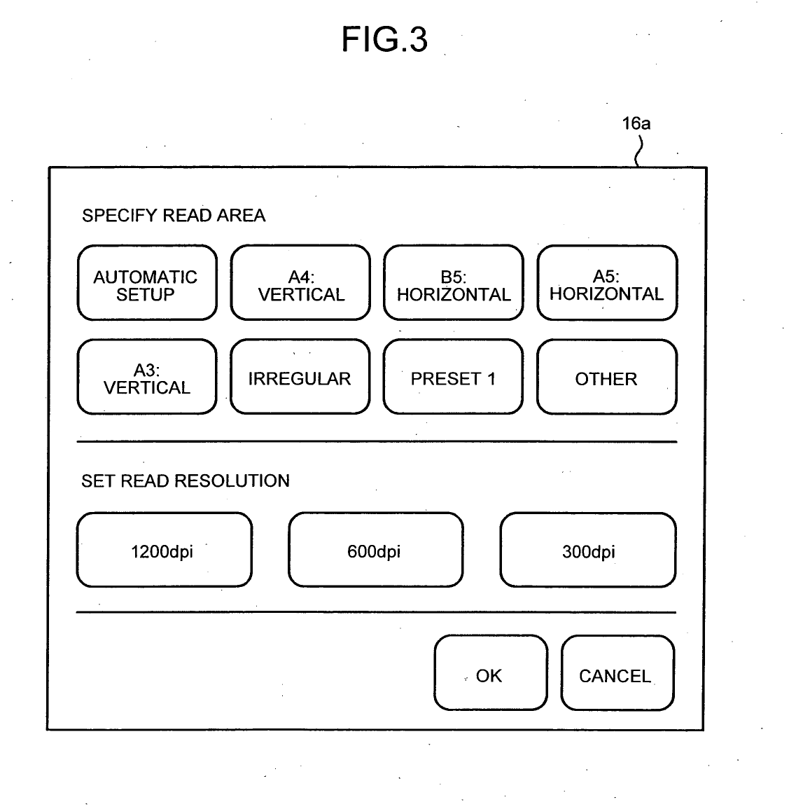

The “scan to memory operation” is an operation such that the copy machine 100 reads a document by the SBU 24 and stores digital image data obtained in the MEM 15. The user puts the document on a document table provided in the SBU 24, and sets read conditions which are variable by an input operation through the liquid-crystal touch panel 16. FIG. 3 is a diagram for explaining a setting screen 16a for read conditions displayed on the liquid-crystal touch panel 16. In FIG. 3, there are choices of eight types for specifying a read area, and choices of three types for setting read resolution displayed thereon. Respective keys for choice, and confirm (OK) button and cancel button for setting are also displayed thereon.

By specifying the read area and setting the read resolution through the operation of the respective keys, and by pressing the confirm button, the read conditions set by the user are transmitted to the process controller 20 and the system controller 10, respectively.

The process controller 20 stores the read conditions received in the RAM(2) 21, and instructs the SBU 24, the CDIC 25, and the IPP 27 to perform the operations according to the read conditions.

The system controller 10 stores the read conditions received in the RAM(1) 11, and instructs the IMAC 14 and the MEM 15 to perform the operations according to the read conditions. After completion of the instructions to the units, the SBU 24 reads the document set on the document table, and transmits digital image data for the document to the CDIC 25. The CDIC 25 transmits the digital image data received to the IPP 27. The IPP 27 performs image processing thereon to compensate for optical characteristics of the SBU 24, and transmits the digital image data image-processed to the CDIC 25. The CDIC 25 transmits the digital image data received to the IMAC 14 through a parallel bus. The IMAC 14 converts the digital image data to a form so as to be accumulated in the MEM 15.

During the operations, the respective statuses of the SBU 24, the IPP 27, and the CDIC 25 are sequentially notified to the process controller 20, and the respective statuses of the IMAC 14 and the MEM 15 are sequentially notified to the system controller 10. When storage of the digital image data is finished, the system controller 10 displays a message to this effect on the liquid-crystal touch panel 16, and finishes the “scan to memory operation”.

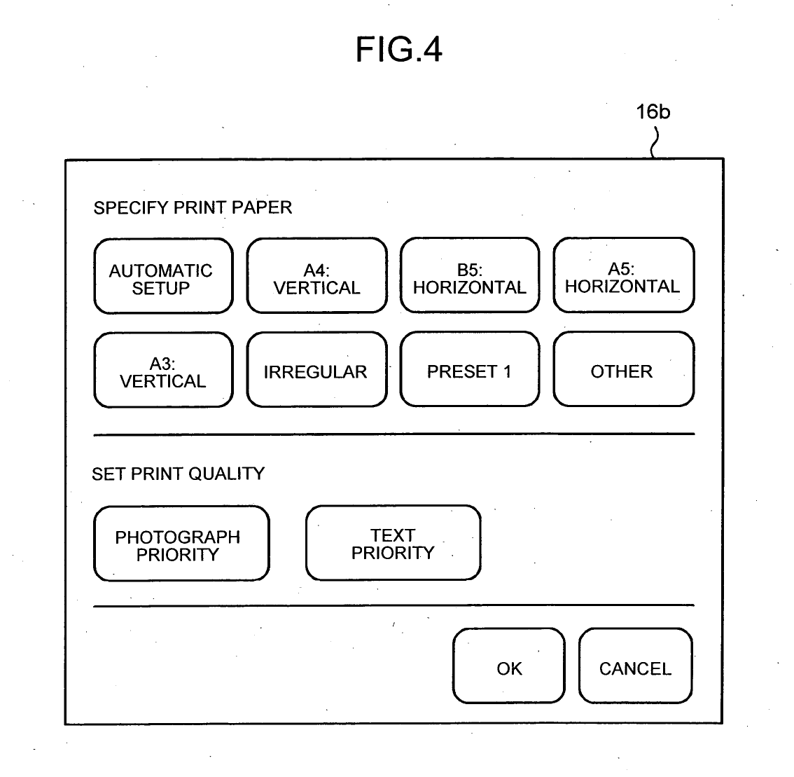

The “memory to print operation” is an operation such that the copy machine 100 prints out the digital image data stored in the MEM 15 onto the sheet, as a reproduced image. The user sets print conditions, which are variable, by an input operation through the liquid-crystal touch panel 16. FIG. 4 is a schematic for illustrating a setting screen 16b for print conditions displayed on the liquid-crystal touch panel 16. In FIG. 4, there are choices of eight types for specifying a print paper, and choices of two types for setting print quality displayed thereon. Respective keys for choice, and confirm (OK) button and cancel button for setting are also displayed thereon.

By specifying the print paper and setting the print quality through the operation of the respective keys, and by pressing the confirm button, the copy machine 100 transmits the print conditions set by the user to the process controller 20 and the system controller 10, respectively.

The process controller 20 stores the print conditions received in the RAM(2) 21, and instructs the CDIC 25, the IPP 27, and the VCU 28 to perform the operations according to the print conditions. The system controller 10 stores the print conditions received in the RAM(1) 11, and instructs the IMAC 14 and the MEM 15 to perform the operations according to the print conditions.

After completion of the instructions to the units, the IMAC 14 reads the digital image data used for printing, from the MEM 15, and recovers it into the image form before the image is stored. The IMAC 14 then transmits the image data to the CDIC 25 through the parallel bus. The CDIC 25 transmits the image data received to the IPP 27.

The IPP 27 performs image processing on the image data to compensate for print conditions set by the user and print characteristics of the VCU 28, and transmits the digital image data image-processed to the VCU 28. The VCU 28 plots the sheet using the digital image data transmitted from the IPP 27, to reproduce the image. During the operations, the respective statuses of the CDIC 25, the IPP 27, and the VCU 28 are sequentially notified to the process controller 20, and the respective statuses of the IMAC 14 and the MEM 15 are sequentially notified to the system controller 10. When reproduction of the image by the VCU 28 is finished, the process controller 20 displays a message to this effect on the liquid-crystal touch panel 16, and finishes the “memory to print operation”.

The “memory to network operation” is an operation such that the copy machine 100 transmits the digital image data stored in the MEM 15 to an external copy machine connected to the IP network 50.

The IMAC 14 reads the digital image data from the MEM 15 and recovers it to the image form before it is stored, and then transmits the digital image data to the CDIC 25 through the parallel bus.

The CDIC 25 transmits the digital image data transmitted from the IMAC 14 to the IPP 27. The IPP 27 subjects the digital image data to image processing such that it is converted into an image form so as to be transferable to the IP network 50. The digital image data image-processed in the IPP 27 is again transmitted to the CDIC 25.

The CDIC 25 transmits the digital image data transmitted from the IPP 27 to the NCU 19 through the parallel bus. The NCU 19 divides the digital image data into pieces of packet data and outputs them to the IP network 50. During the operations, the respective statuses of the IMAC 14, the MEM 15, and the NCU 19 are sequentially notified to the system controller 10.

When the NCU 19 finishes the output of the digital image, the system controller 10 displays a message to this effect on the liquid-crystal touch panel 16, to finish the “memory to network operation”. The digital image data output onto the IP network 50 has been processed so as to follow a communication protocol of the IP network 50, and hence, the digital image data reaches up to a copy machine as a destination through various types of information processing terminals.

The “network to memory operation” is an operation such that the copy machine 100 receives digital image data sent from an external copy machine or from an information processing terminal connected to the IP network 50, and accumulates it in the MEM 15.

The NCU 19 recovers the packet data transmitted through the IP network 50 to the digital image data, and transmits the digital image data recovered to the CDIC 25 through the parallel bus.

The CDIC 25 transmits the digital image data transmitted from the NCU 19 to the IPP 27. The IPP 27 performs image processing on the digital image data transmitted from the CDIC 25 so as to be converted to an image form adequate for use in the machine, and again transmits the digital image data after the processing to the CDIC 25.

The CDIC 25 transmits the digital image data transmitted from the IPP 27 to the IMAC 14 through the parallel bus. The IMAC 14 converts the digital image data to a storage form specified by the MEM 15, to store it in the MEM 15. During the operations, the respective statuses of the IMAC 14, the MEM 15, and the NCU 19 are sequentially notified to the system controller 10. When the storage of the digital image in the MEM 15 is finished, the system controller 10 displays a message to this effect on the liquid-crystal touch panel 16, to finish the “network to memory operation”.

The “find operation” indicates an operation such that the copy machine 100 acquires destination information for a copy machine of the other party. That is, in the “find operation”, the copy machine 100 acquires a user's telephone number and a called party's telephone number, and transmits the user's telephone number and the called party's telephone number acquired and a communication address of the copy machine 100 held by the copy machine 100, to the server 200. The server 200 stores the user's telephone number, the called party's telephone number, and the communication address of the copy machine of the user received, in such a manner that these are related to one another. The server 200 searches for a communication address of a copy machine used by the other party based on the user's telephone number and the called party's telephone number, and transmits the communication address of the copy machine of the other party to the copy machine 100.

In this case, a specific method is employed in such a manner that when both users of the data transmission/reception system are communicating on the telephone, respective pieces of destination information as IP addresses of copy machines used by the users are determined from the user's telephone number and the called party's telephone number of the telephone sets being used for the telephone conversation, to acquire the respective pieces of destination information.

There are two types of methods as to how the copy machine 100 acquires a user's telephone number and a called party's telephone number. One of them as a first method is that the user manually inputs the user's telephone number and the called party's telephone number into the copy machine 100. The other one as a second method is that the copy machine 100 and the telephone set 71 perform communication using the TIFU 17 so that the copy machine 100 acquires the user's telephone number and the called party's telephone number.

The process procedure for the first method of manually inputting these numbers is explained below. The user enters the user's telephone number and the called party's telephone number by an input operation to the liquid-crystal touch panel 16.

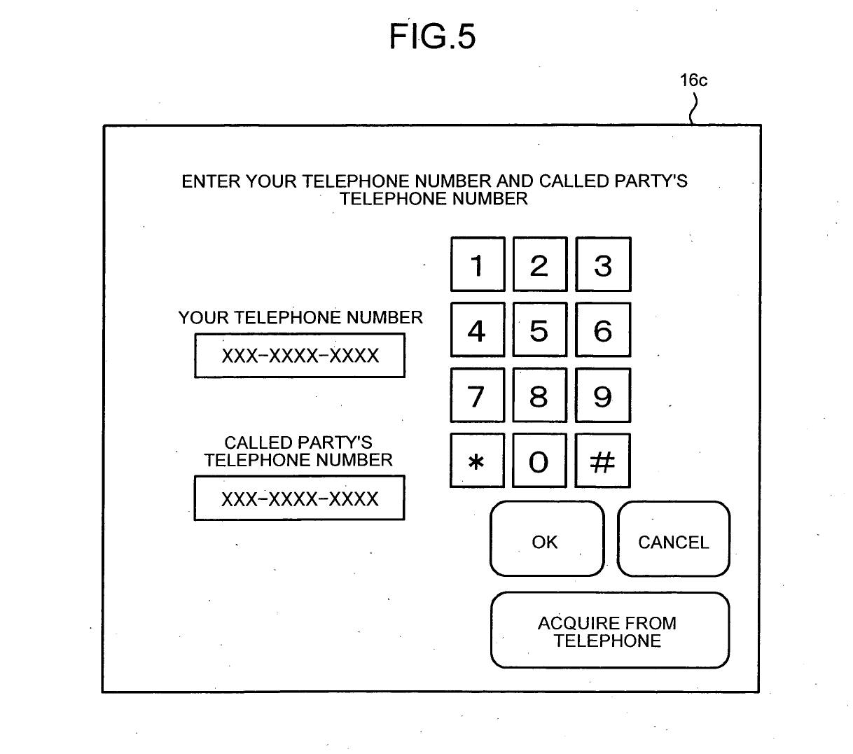

FIG. 5 is a schematic for illustrating an entry screen 16c displayed on the liquid-crystal touch panel 16. In FIG. 5, a prompt to enter the user's telephone number and the called party's telephone number is displayed thereon, and boxes for entering the respective telephone numbers of the telephone sets used by the user and the called party, the numeric keypad for entry, and “confirm (OK) button” and “cancel button” for the entry are also displayed thereon.

The user uses the numeric keypad provided on the entry screen to enter the user's telephone number and the called party's telephone number, and presses the “confirm button” when all the entries are complete. When the “confirm button” is pressed, the liquid-crystal touch panel 16 notifies the system controller 10 of the entry result confirmed. When receiving the notification, the system controller 10 stores the user's telephone number and the called party's telephone number in the RAM(1) 11.

The process procedure for the second method of entering these numbers using the TIFU 17 is explained below. The liquid-crystal touch panel 16 displays a button indicating “acquire from telephone” in the entry screen 16c (FIG. 5). When this button is pressed, the liquid-crystal touch panel 16 is switched to a screen that instructs communication between the copy machine 100 and the telephone set 71.

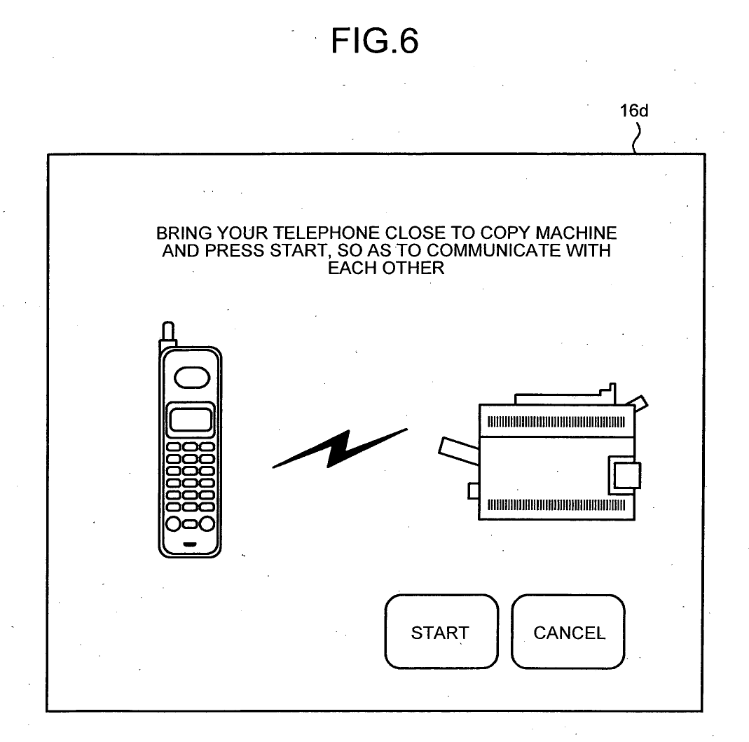

FIG. 6 is a schematic for illustrating an entry screen 16d for prompting entry from the telephone set 71. In FIG. 6, a message for notifying that the copy machine 100 and the telephone set 71 used for making a call will perform communication, and “start button” and “cancel button” for prompting execution/cancellation are displayed thereon.

When the second method is to be executed, the user puts the telephone set 71 used for a telephone conversation, close to the copy machine 100 according to the guidance displayed on the entry screen of FIG. 6, to press the “start button” on the entry screen of the liquid-crystal touch panel 16. When the “start button” is pressed, the liquid-crystal touch panel 16 notifies the system controller 10 of the entry result such that execution is instructed.

After reception of this notification, the system controller 10 performs communication with the telephone set 71 using the TIFU 17, to acquire the user's telephone number and the called party's telephone number. The system controller 10 then stores these telephone numbers acquired in the RAM(1) 11.

The system controller 10 uses the NCU 19 to transmit the IP address specific to the copy machine 100, the user's telephone number and the called party's telephone number acquired in the above manner, and the communication address of the copy machine 100 to the server as an external information source. The server 200 checks information to be managed, and searches for destination information for a copy machine that is used by the other party, required for operation of “copy machine-to-copy machine” on the IP network 50, to acquire the destination information. The server 200 transmits the destination information acquired to the copy machine 100.

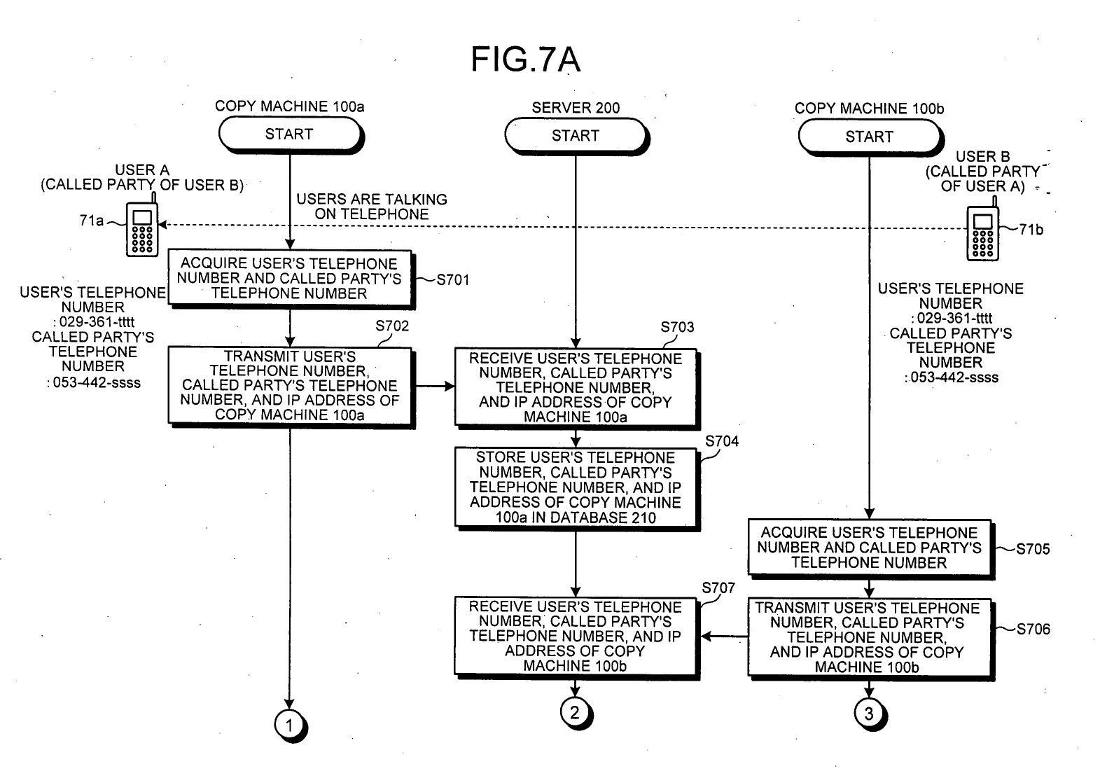

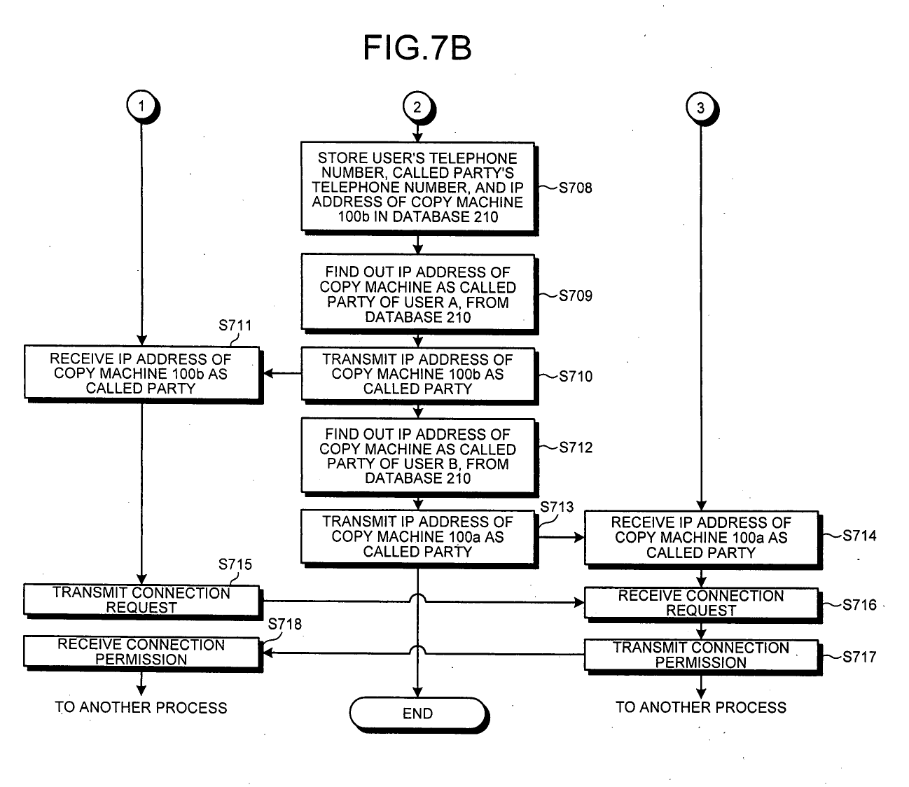

FIG. 7A and FIG. 7B are flowcharts for procedures of the Find process. A user A and a user B, which are about to transmit and receive image data, are talking on the telephone using the telephone set 71a and the telephone set 71b. The copy machine 100a used by the user A acquires the user's telephone number and the called party's telephone number (step S701). More specifically, the copy machine 100a acquires “029-361-tttt” being the user's telephone number of the telephone set 71a used by the user A and “053-442-ssss” being the called party's telephone number of the telephone set 71b of the user B that is the called party of the user A, from the telephone set 71a of the user A. The telephone set 71a holds the telephone number of the telephone set 71b of the user B that is the called party of the user A by the other party's number notifying function that is included in the telephone set 71a itself.

In order to inquire about a communication address of the copy machine 100b as the other party, the copy machine 100a transmits two telephone numbers (the user's telephone number and the called party's telephone number) acquired and the IP address of the copy machine 100a held by the copy machine 100a itself, to the server 200 (step S702). More specifically, the copy machine 100a transits the user's telephone number “029-361-tttt”, the called party's telephone number “053-442-ssss”, and the IP address of the copy machine 100a. The server 200 receives the user's telephone number, the called party's telephone number, and the IP address of the copy machine 100a transmitted from the copy machine 100a (step S703). The server 200 stores these telephone numbers and the IP address of the copy machine 100a received, in the user information database 210 (step S704).

The copy machine 100b used by the user B acquires a user's telephone number and a called party's telephone number (step S705). More specifically, the copy machine 100b acquires “053-442-ssss” being the user's telephone number of the telephone set 71b used by the user B and “029-361-tttt” being the called party's telephone number of the telephone set 71a of the user A that is the called party of the user B, from the telephone set 71b being used by the user B. The telephone set 71b holds the telephone number of the telephone set 71a of the user A that is the called party of the user B by the other party's number notifying function that is included in the telephone set 71b itself.

In order to inquire about a communication address of the copy machine 100a as the other party, the copy machine 100b transmits two telephone numbers (the user's telephone number and the called party's telephone number) and the IP address of the copy machine 100b held by the copy machine 100b itself acquired, to the server 200 (step S706). More specifically, the copy machine 100b transmits the user's telephone number “053-442-ssss”, the called party's telephone number “029-361-tttt”, and the IP address of the copy machine 100b. The server 200 receives the user's telephone number, the called party's telephone number, and the IP address of the copy machine 100b transmitted from the copy machine 100b (step S707). The server 200 stores these telephone numbers and the IP address of the copy machine 100b received, in the user information database 210 in such a manner that these are related to one another (step S708).

In order to acquire an IP address of the copy machine 100a, the server 200 finds out an IP address of the copy machine 100b used by the user B that is the other party of the user A, from the user information database 210 (step S709). In other words, the server 200 searches the user information database 210 using those, as a search key, obtained by replacing the user's telephone number and the called party's telephone number transmitted from the copy machine 100 with each other, and acquires a set of the user's telephone number and the called party's telephone number as the search target, the set having the same telephone numbers as the search key. The server 200 acquires the IP address of the copy machine 100b, which is related to the user's telephone number and the called party's telephone number, as the destination information. This case is more specifically explained with reference to the content of the user information database of FIG. 8. If the user's telephone number of the user A is “029-361-tttt” and the called party's telephone number is “053-442-ssss”, the server 200 searches for the user information such that the user's telephone number of the user A is “053-442-ssss” and the called party's telephone number is “029-361-tttt”, from the user information database 210 of the server 200. The IP address of the copy machine 100b used by the user B is searched for from this user information. As the result of this process, it is found out that the IP address of the copy machine 100b used by the user B that is the other party of the user A is “ff00:0101:0218:1224:0126:9723:0640:xxxx”.

The server 200 transmits the IP address of the copy machine 100b as the other party, to the copy machine 100a (step S710). The copy machine 100a receives the IP address of the copy machine 100b as the other party, from the server 200 (step S711).

In order to acquire an IP address of the copy machine 100b, the server 200 finds out the IP address of the copy machine 100a used by the user A that is the other party of the user B, from the user information database 210 (step S712). This case is more specifically explained with reference to the content of the user information database of FIG. 8. If the user's telephone number of the user B is “053-442-ssss” and the called party's telephone number is “029-361-tttt”, the server 200 searches for and acquires the user information such that the user's telephone number of the user A is “029-361-tttt” and the called party's telephone number is “053-442-ssss”, from the user information database 210 of the server 200, conversely to the case of the user A. The IP address is identified from this user information acquired. As the result of this process, it is found out that the IP address of the copy machine 100a used by the user A that is the other party of the user B is “0123:4567:02D8:1324:1068:9453:yyyy”.

The server 200 transmits the IP address of the copy machine 100a that is the other party of the copy machine 100b, to the copy machine 100b (step S713). The copy machine 100b receives the IP address of the copy machine 100a as the other party (step S714).

Since the copy machine 100a acquires the IP address of the copy machine 100b, the copy machine 100a transmits a connection request signal to the copy machine 100b, to request a connection (step S715). The copy machine 100b receives the connection request signal from the copy machine 100a (step S716). The copy machine 100b transmits a connection permission signal, to permit the connection (step S717). The copy machine 100a receives the connection permission signal transmitted from the copy machine 100b (step S718). Thereafter, the copy machine 100a executes the “scan to memory operation”, and the copy machine 100b executes the “memory to print operation”. Text data read from the copy machine 100a used by the user A is thereby transmitted to the copy machine 100b used by the user B. As a result, the user B can acquire required text data from a nearby copy machine with an easy operation.

The process of storing the user information in the user information database 210 of the server 200 (step S701 to step S704, and step S705 to step S708) is an independent process performed by the copy machine 100a or the copy machine 100b, and hence, either one of the processes may be performed prior to the other process, or the processes may be performed in parallel.

In this manner, a first copy machine used by a user transmits the user's telephone number, the called party's telephone number, and the communication address of the first copy machine to a server, and the server acquires a communication address of a second copy machine as the other party, to connect between the first and second copy machines. In this case, there is no need for the user to specify an IP address and a MAC address which require such an operation that is troublesome and easy to make a mistake, or to specify a specific character/number string from which a relevant address can be solved. This case allows easy transmission and reception of image information between the first and second copy machines.

A copy machine acquires the user's telephone number and the called party's telephone number from a telephone set through short-distance communication, and transmits these telephone numbers together with the communication address of the copy machine, to a server. Consequently, image information can be transmitted and received between the copy machines with easier operation where there is no need for the user to manually enter the user's telephone number and the called party's telephone number.

Because there is no need to enter an IP address and a MAC address which are very complicated and difficult to remember and there is no need to enter a specific name from which a relevant address can be solved, a character string including an alphanumeric character and a symbol is unnecessary to be entered, thereby preventing miss-operation due to typing errors by a user. By entering such a telephone number that every one is accustomed to handle, in the copy machine, connection with a desired copy machine can be established without user's being conscious of an IP address assigned to the copy machine at destination. Therefore, a system with high operability for users can be provided.

Moreover, since a user has made a contact, through a telephone, with a person to whom a document is transmitted, the user can transmit the text data to the person that is identified, with a sense of security.

Since users can acquire respective IP addresses of copy machines, which are not mutually known by the users, through the server 200, copy machines which have never exchanged text data can transmit and receive the text data. Therefore, even when the user A is in the office and the user B is somewhere outside the office, the user A can send text data from the copy machine in the office to any copy machine near the user B that is outside the office.

Since the IP address, the MAC address, and the specific name are not made open, malicious actions (junk e-mails) such that advertisement and solicitation e-mails are sent to the general public can be prevented.

FIG. 8 is a schematic for illustrating the data transmission/reception system according to the first embodiment. The data transmission/reception system is constructed by respectively connecting the copy machine 100a, the copy machine 100b, and the copy machine 100c, and the server 200 being an external information source, to the IP network 50. The server 200 collects the user's telephone numbers, the called party's telephone numbers, and the IP addresses from the copy machine 100a, the copy machine 100b, and the copy machine 100c, respectively, to manage these data as a database.

For example, in order to acquire destination information for a copy machine as the other party, the copy machine 100a transmits the user's telephone number, the called party's telephone number, and the IP address to the server 200. When the user's telephone number, the called party's telephone number, and the IP address are transmitted from the copy machine 100a, the server 200 acquires an IP address related to a user's telephone number and a called party's telephone number from the user information database 210, the IP address being obtained by replacing the user's telephone number and the called party's telephone number acquired from the copy machine 100a with each other. The server 200 sends the IP address acquired from the user information database 210 as an IP address of the copy machine 100b, to the copy machine 100a.

When the destination information cannot be found out instantly even after the searching, the server 200 notifies the copy machine 100a of such an effect that it is during searching, and continues the searching. If the destination information cannot be found out from the database in a predetermined time, the server 200 notifies the copy machine 100a of failure of the searching, and terminates the searching.

If three or more telephone sets are used to have a telephone conversation among multi-parties, the server 200 searches for a plurality of copy machines each corresponding to the copy machine 100b in the above case. In this case, the server 200 sends the IP addresses of all the copy machines obtained through the search result as required destination information, to the copy machine 100a. The server 200 also sends the IP address of the copy machine as destination information, to respective copy machines from which the user's telephone number, the called party's telephone number, and the IP address are transmitted.

The copy machine 100a transmits the user's telephone number, the called party's telephone number, and the IP address to the server 200, and waits for destination information for the other party sent from the server 200. When receiving the destination information from the server 200, the copy machine 100a stores the destination information received in the RAM(1) 11, to finish “find operation”. In this case, if “during searching” is notified, the copy machine 100a displays a message to this effect on the liquid-crystal touch panel 16, and continues waiting for the destination information. If “failure of searching” is notified, the copy machine 100a displays a message to this effect on the liquid-crystal touch panel 16, to finish “find operation”.

The “compare operation” is an operation such that the copy machine 100 acquires a password from a user to check image information that is to be transmitted and received for performing the operation of “copy machine-to-copy machine”, transmits the password acquired to a copy machine connected thereto and receives a password therefrom, and compares the passwords with each other to determine whether the passwords match each other.

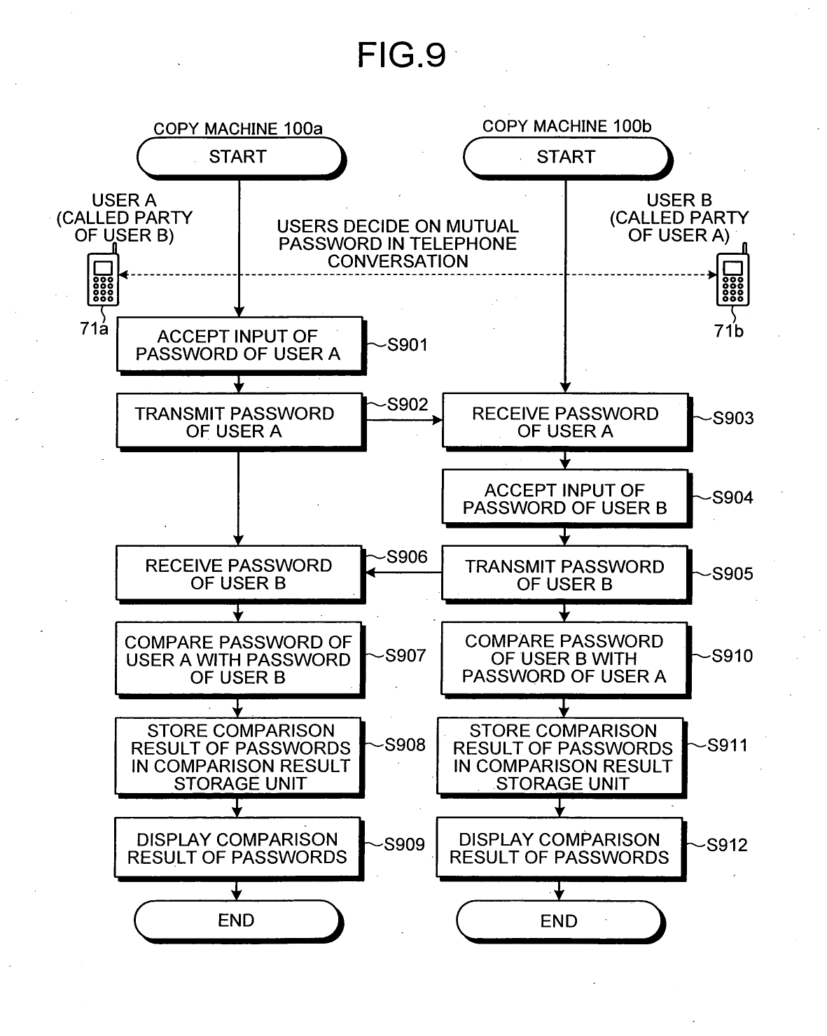

The compare process based on the two copy machines configured in the above manner is explained below. FIG. 9 is a flowchart of the compare process.

The user A and the user B, that are about to transmit and receive image data, are talking using the telephone set 71a and the telephone set 71b, and decide on a mutual password with each other. The copy machine 100a accepts an input of the user A's password entered by the user A (step S901). The copy machine 100a transmits the user A's password to the copy machine 100b (step S902). The copy machine 100b receives the user A's password transmitted from the copy machine 100a (step S903).

The copy machine 100b accepts an input of the user B's password entered by the user B (step S904). The copy machine 100b transmits the user B's password to the copy machine 100a (step S905). The copy machine 100a receives the user B's password transmitted from the copy machine 100b (step S906).

The copy machine 100a compares the user A's password with the user B's password transmitted to determine whether the user A and the user B are talking on the telephone (step S907). The copy machine 100a stores the comparison result of the passwords in a comparison result storage unit (step S908). More specifically, if there is a match between the passwords, then “match” is stored therein as the comparison result, but if there is no match, then “non-match” is stored therein as the comparison result. The copy machine 100a displays the comparison result of the passwords on the liquid-crystal touch panel 16 (step S909).

The copy machine 100b compares the user B's password with the user A's password transmitted (step S910). The copy machine 100b stores the comparison result of the passwords in a comparison result storage unit (step S911). The copy machine 100b displays the comparison result of the passwords on the liquid-crystal touch panel 16 (step S912).

The transmission process of the password (steps S901 to S903, and steps S904 to S906) is the process independently performed by the copy machine 100a or the copy machine 100b, and hence, either one of the processes may be performed prior to the other process, or the processes may be performed in parallel.

In this manner, since the copy machine according to the first embodiment includes the “compare operation”, even if the connection is established by the “find operation”, transmission or reception of the text is not started before the mutual password is entered. Therefore, the text data can reliably be transmitted and received between those that talk on the telephone. Moreover, the mutual password is decided on the spot by the users that are talking on the telephone, that is, the mutual password is not previously stored, which allows transmission and reception of text with high reliability without worrying about password theft by hacking or the like.

Even after the connection with a desired copy machine is established, the users can identify each other, to enable transmission and reception of text data that requires high security. For example, even when the user views various Web sites by clicking on a hyperlink over the Internet displayed on the screen with a pointing device such as a mouse, the user can confirm transaction of the text data with the other party on the telephone, thereby preventing the user from being involved in crime such as a phishing scam.

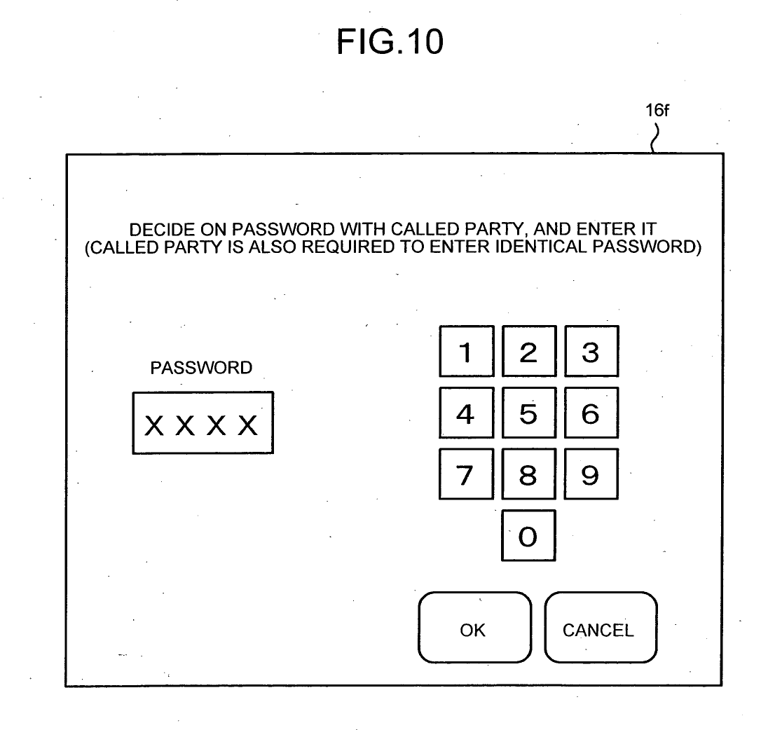

FIG. 10 is a schematic for illustrating an entry screen 16f for entry of a password, displayed on the liquid-crystal touch panel 16. The copy machine 100 displays a message for prompting entry of a mutual password decided by both the user and the other party, that transmit and receive image information, and displays an entry box for the password, a numeric keypad used for entry of data, and “confirm (OK) button” and “cancel button” for entry of the data.

The user enters the mutual password decided using the numeric keypad. The mutual password can be decided by the users that mutually accept it through the talking on the telephone, and four digits of numbers are used as the password in FIG. 10. The user enters the password using the numeric keypad and presses the “confirm button”, thereby the liquid-crystal touch panel 16 makes the entry complete. When the “confirm button” is pressed, the liquid-crystal touch panel 16 notifies the system controller 10 of entry completion.

After reception of the notification, the system controller 10 stores the password entered in the RAM(1) 11. The system controller 10 exchanges the password entered into the copy machine and the password entered into a copy machine used by the other party, and compares the passwords with each other. If there is a match between the passwords, then the system controller 10 displays a message to that effect on the liquid-crystal touch panel 16, to finish the “compare operation”. If there is no match therebetween, the system controller 10 displays a message for prompting reentry of the passwords on the liquid-crystal touch panel 16, and performs again the “compare operation”. If there is no match even after the operation is performed predetermined times, the system controller 10 terminates transmission or reception of image information.

The “negotiation operation” is such that the copy machine 100 is made to perform an operation in which the result of negotiation between the user and the other party is reflected before the copy machine 100 performs transmission or reception of image information. For example, if a plurality of copy machines 100 are connected to each other, setting becomes possible for each copy machine 100 according to the result of negotiation as to whether transmission or reception of the image information is executed.

If the use of the copy machine 100 is charged, how to pay for it is decided through negotiation on the telephone. The APU 18 charges based on a set charging rate decided through negotiation, so that the charge reflects the result of negotiation.

The control of the “negotiation operation” is performed by adding processes as follows. That is, the liquid-crystal touch panel 16 displays an entry screen for setting operation conditions based on the result of negotiation, and accepts a setting operation entered through the entry screen. The system controller 10 stores the set data confirmed by the operation of the “confirm button” in the RAM(1) 11.

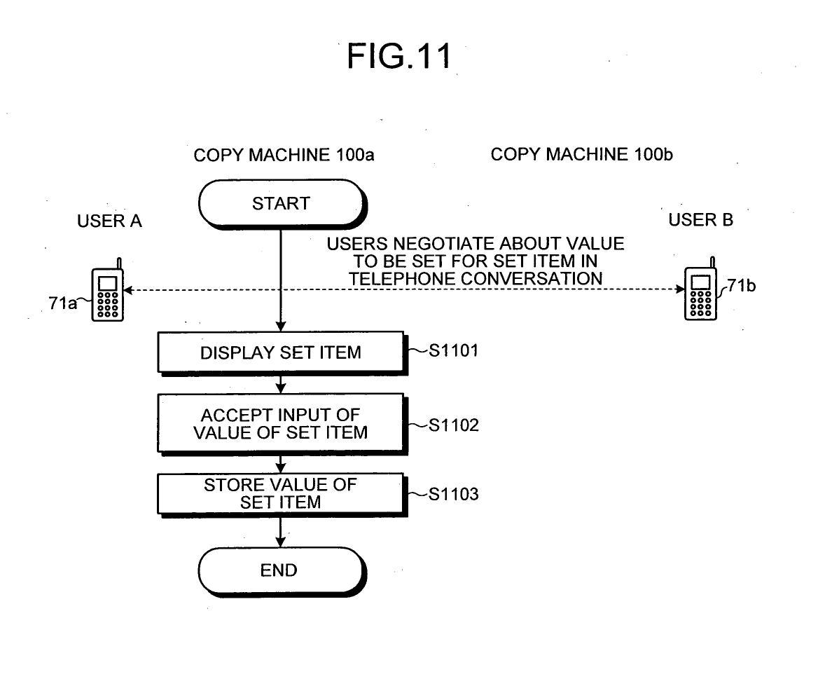

The negotiation process by the copy machine configured in the above manner is explained below. FIG. 11 is a flowchart of the negotiation process.

At first, the user A and the user B, that are about to transmit and receive image data, are talking on the telephone using the telephone set 71a and the telephone set 71b, and negotiate about a value of an set item that requires negotiation on the telephone, to decide on the value. The negotiation and acceptance of the value of the set item by the telephone set 71a and the telephone set 71b may be performed after the set item is displayed. The copy machine 100a displays the set item on the liquid-crystal touch panel 16 (step S1101). More specifically, the set item includes those such as a payment rate if the use of the copy machine 100 is charged and selection of the copy machine 100 to which image data is transmitted if a plurality of copy machines 100 used by users are connected to each other.

The copy machine 100a accepts an input of the value of the set item (step S1102). For example, if the set item is the payment rate which is made for use of each copy machine, then the result of negotiation with the user B is entered. If the set item is selection of a target of image data transmission, the target selected is entered by the user A. The copy machine 100a stores the values of the set items entered in the memory (step S1103).

When the copy machines are connected to the system, whether to transmit image information to the respective copy machines can be set at a time, thereby reducing a load of operation performed by the user. Moreover, the result of negotiation on a charging rate on the copy machine performed on the telephone can be instantly reflected in the system, thereby reducing a load of post-operation required after the task is finished.

The “disconnect operation” is an operation such that when the copy machine 100 does not transmit and receive image information to and from a copy machine of the other party for a predetermined time or more, the copy machine 100 disconnects the connection based on determination by the copy machine 100 itself. This operation is executed to protect the machines themselves when the copy machines are left in a status of being connected to each other and yet not performing transmission and reception.

The “disconnect operation” according to the first embodiment employs such a way that the connection is not instantly disconnected after a predetermined time has elapsed since connection is established between the copy machines, but that two steps are provided before the connection is actually disconnected in such a manner that each step is made to shift to the next step after a predetermined time has elapsed.

More specifically, at the first step, when the copy machine does not transmit or receive image information to or from the copy machine 100 used by the other party for a predetermined time, the system controller 10 displays a message for confirming intension of the user to continue the connection on the liquid-crystal touch panel 16. If there is no response from the user although the message is displayed thereon, the comparison result of the passwords executed in the “compare operation” is invalidated. Consequently, in order to restart transmission and reception of image information, it is necessary to enter passwords again and verify whether the passwords match each other.

In this stage, the image information can be transmitted or received after the passwords are entered again and checked. However, the passwords are not entered again, and further, if the image information are not transmitted or received to or from a copy machine connected thereto for a predetermined time, the system controller 10 displays a message indicating “disconnection of the connection” on the liquid-crystal touch panel 16. If there is no response from the user although the message is displayed thereon, the connection is actually disconnected, to finish “disconnect operation”.

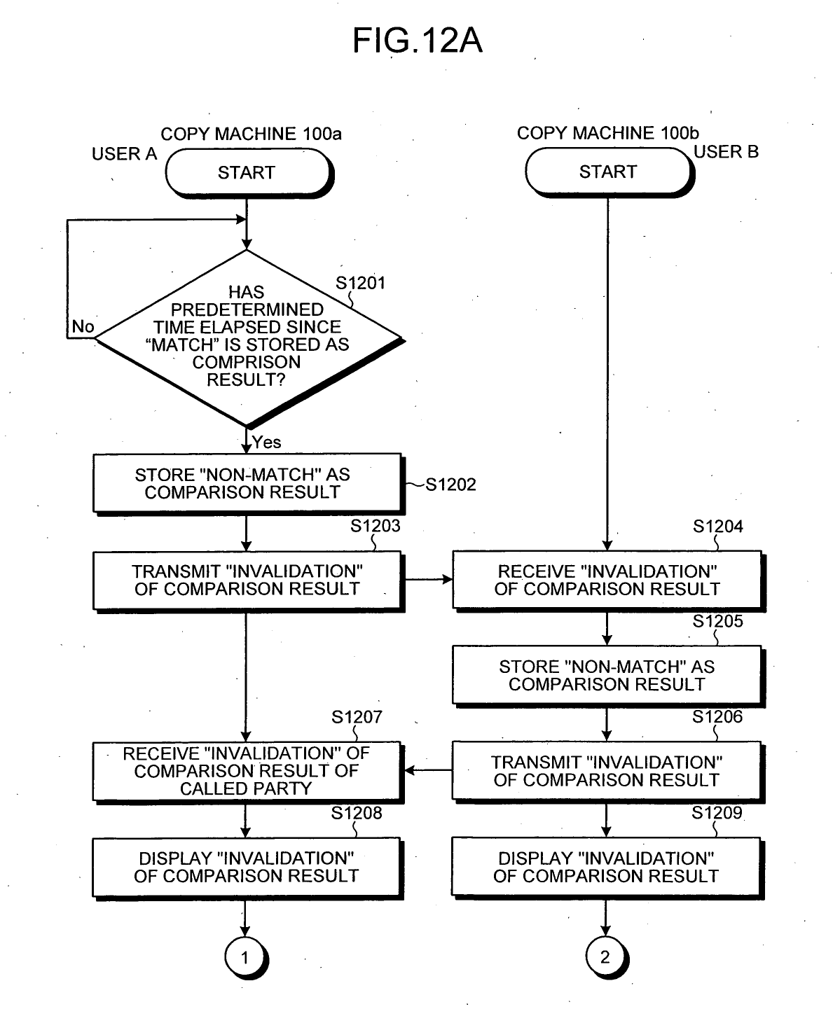

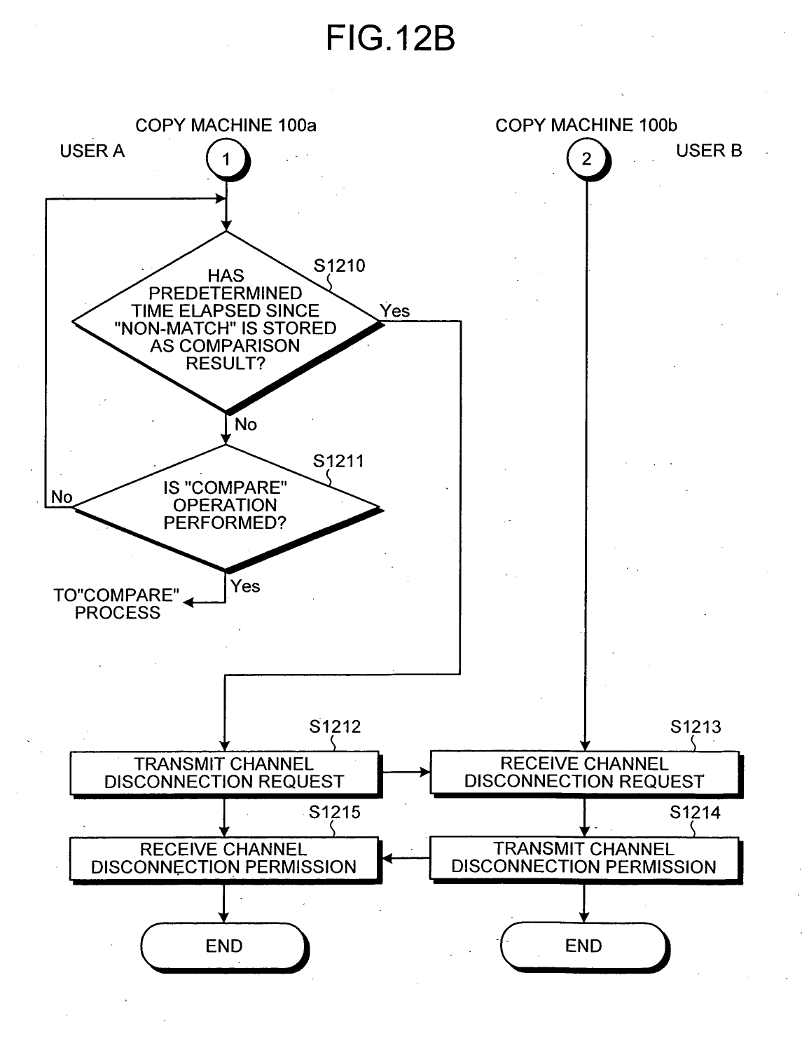

The disconnect process by the two copy machines 100a and 100b each configured in the above manner is explained below. FIG. 12A and FIG. 12B are flowcharts of the disconnect processes.

The copy machine 100a determines whether a predetermined time has elapsed from the time when “match” has been stored in the comparison result storage unit as the comparison result (step S1201). If it is determined that the predetermined time has not elapsed (“NO” at step S1201), then the process returns to step S1201. If it is determined that the predetermined time has elapsed (“YES” at step S1201), the copy machine 100a stores “non-match” as the comparison result of the passwords (step S1202).

The copy machine 100a transmits “invalidation” of the comparison result of the passwords (step S1203). The copy machine 100b receives the “invalidation” of the comparison result of the passwords from the copy machine 100a (step S1204). The copy machine 100b stores “non-match” as the comparison result of the passwords (step S1205). The copy machine 100b transmits “invalidation” of the comparison result of the passwords (step S1206).

The copy machine 100a receives the “invalidation” of the comparison result of the passwords transmitted from copy machine 100b (step S1207). The copy machine 100a displays the “invalidation” on the liquid-crystal touch panel 16 (step S1208). The copy machine 100b also displays the “invalidation” on the liquid-crystal touch panel 16 (step S1209).

The copy machine 100a determines whether a predetermined time has elapsed from the time when “non-match” as the comparison result has been stored in the comparison result storage unit (step S1210). If it is determined that the predetermined time has not elapsed (“NO” at step S1210), then the copy machine 100a determines whether “compare operation” is performed (step S1211). If it is determined that the “compare operation” is performed (“YES” at step S1211), then the copy machine 100a performs the compare process. If it is determined that the “compare operation” is not performed (“NO” at step S1211), the process returns to step S1210.

At step S1210, if it is determined that the predetermined time has elapsed (“YES” at step S1210), the copy machine 100a transmits a channel disconnection request signal to the copy machine 100b, and requires the disconnection (step S1212). The copy machine 100b receives the channel disconnection request signal (step S1213). The copy machine 100b transmits a channel disconnection permission signal to permit the disconnection (step S1214). The copy machine 100a receives the channel disconnection permission signal (step S1215).

When the channel is disconnected, the user information may be deleted from the server 200.

The mechanism of disconnecting the connection in two stages is provided in the “disconnect operation” whenever a predetermined time has elapsed. Thus, it is prevented that the copy machines are left connected, so that the copy machines will never be left connected when the users finish the business and the telephones are disconnected. Furthermore, the copy machine, which is failed to be disconnected, can be protected from unauthorized use by a malicious person. Moreover, since the connection is disconnected step by step, if the time when the copy machines are left connected is comparatively short, the process for restarting text transmission or reception can be simplified.

The “scan to memory operation”, “Memory to Print operation”, “memory to network operation”, “network to memory operation”, “find operation”, “compare operation”, “negotiation operation”, and “disconnect operation” are respectively shown as basic operations of the copy machine 100. However, only one of them may be executed or a combination of a plurality of the basic operations may be executed.

In the latter case, each timing at which the user performs various settings through the liquid-crystal touch panel 16 is not necessarily set during interval between the basic operations. The settings may be collectively performed at arbitrary timing. The reason is that the contents of the settings are stored in either one of the RAM(1) 11 and the RAM(2) 21, and the system controller 10 can read the contents at any time.

The “copy machine-to-copy machine” function in the data transmission/reception system that includes the copy machine 100 (FIG. 1) and a server 200 is explained below.

FIG. 13 is a diagram for explaining one example of a data transmission/reception system according to a second embodiment of the present invention. In the second embodiment, only three copy machines and one server 200 are connected to the IP network 50, for simplicity of explanation. The copy machines are called “copy machine 100a”, “copy machine 100b”, and “copy machine 100c”, and user names of the copy machines are called “A”, “B”, and “C”, respectively. IP addresses of the “copy machine 100a”, the “copy machine 100b”, and the “copy machine 100c” are set as “IP address A”, “IP address B”, and “IP address C”, respectively.

In the second embodiment, it is assumed that the users “A”, “B”, and “C” of the copy machines can talk on the telephone, and hence, the users have the telephone sets 71a, 71b, and 71c through a telephone line 70, respectively.

The operation such that each of the users provides a user's telephone number and a called party's telephone number to the respective copy machines 100a to 100c is called “to check in”. More specifically, this operation indicates an operation of manually entering a user's telephone number and a called party's telephone number through the liquid-crystal touch panel 16. Alternatively, this operation indicates an operation of transmitting a user's telephone number and a called party's telephone number using wireless communication from the telephone sets 71a, 71b, and 71c respectively provided near the copy machines 100a to 100c, to the TIFU 17 provided on each copy machine side (see the explanation of “find operation”). The operation of disconnecting the connection among the copy machines 100a to 100c with the intention of a user is called “to check out”. More specifically, a user tells the intention to disconnect the connection using the liquid-crystal touch panel 16 to the users, and the copy machines 100a to 100c disconnect the connection according to the instruction.

The situation that requires the “copy machine-to-copy machine” function includes a situation such that “A” has to deliver a copy of a paper document to “B” when “A” and “B” are talking on the telephone. At this time, “A” tells “B” on the telephone that “A” wants to deliver the paper document.

Then, “A” checks in the copy machine 100a, and “B” checks in the copy machine 100b. The copy machine 100a and the copy machine 100b send IP addresses of their own machines, respective user's telephone numbers, and called party's telephone numbers to the server 200 by the “find operation”, and acquire destination information as the search result of the other party from the server 200. In this example, the copy machine 100a acquires the IP address B, and the copy machine 100b acquires the IP address A.

The copy machine 100a and the copy machine 100b finish the “find operation”, and start the “compare operation”. “A” talks to “B” on the telephone so as to decide on a mutual password. “A” and “B” enter the password in the copy machine 100a and the copy machine 100b, respectively. Then, the copy machine 100a and the copy machine 100b exchange the passwords to verify whether the passwords match each other. If it is verified that there is a match, the copy machine 100a and the copy machine 100b finish the “compare operation”, so that image information is ready to be transmitted and received between these machines.

Thereafter, “A” sets the paper document on the document table of the copy machine 100a, to instruct the copy machine 100a to read the paper document. And the “negotiation operation” is started, and “A” performs main settings of the “copy machine-to-copy machine” function. At this time, if there are some items to be decided by talking with “B”, such as how to pay for the fee for use charged, then “A” performs the settings based on the contents decided.

After all the set items are decided and the “negotiation operation” is finished, the “scan to memory operation” and the “memory to network operation” are sequentially executed, and the paper document read is sent as a digital image to the copy machine 100b. When receiving the digital image, the copy machine 100b performs the “network to memory operation” and the “Memory to Print operation”, and the copy of the paper document is printed on the paper. By performing the operations, “A” and “B” have the paper documents of the same contents in hand.

Thereafter, “A” and “B” continue talking about the contents of the paper document, and find out a point that both of them do not understand. Therefore, “A” and “B” decide to ask a question to “C”. “A” makes a call to “C” and tells about what the question is (hereinafter, talking among three parties), but the content of the question cannot sufficiently be delivered to “C” only by verbal explanation. Therefore, “A” decides to send the copy of the paper document to “C”.

“C” checks in the copy machine 100c. Then, the copy machine 100c transmits the IP address of its own machine, the user's telephone number, and the called party's telephone number to the server 200, and acquires destination information as the search result from the server 200. More specifically, the copy machine 100c acquires the IP address A and the IP address B. The server 200 transmits the IP address C to the copy machine 100a and the copy machine 100b based on the search result. The copy machine 100c finishes the “find operation”, and then starts the “compare operation”. More specifically, “A” tells the password to “C”, and “C” enters the password into the copy machine 100c. When it is verified that there is a match between the passwords, the copy machine 100c finishes the “Compare operation”, so that image information is ready to be transmitted and received between the copy machine 100a and the copy machine 100c.

However, since the topic about which “A”, “B”, and “C” are talking on the telephone shifts to another topic, “A” fails to immediately send the paper document to “C”, and the three users continue talking for a long time. The copy machine 100a, the copy machine 100b, and the copy machine 100c are resulted in being left connected for a long time. Consequently, the respective machines start the “disconnect operation” to invalidate the comparison result of the passwords. Thereafter, “A”, “B”, and “C” notice the disconnection, and respectively enter again the passwords. As a result, the “compare operation” is performed again between the machines, so that the image information is ready to be transmitted and received among the machines.

Thereafter, “A” executes transmission of the paper document to “C”. “A” sets the paper document on the document table of the copy machine 100a, to instruct the copy machine 100a to read the paper document. And the “negotiation operation” is started, and “A” performs main settings of the “copy machine-to-copy machine” function. At this time, if there are some items to be decided by talking with “B” and “C”, such as how to pay for the fee for use charged, then “A” performs the settings based on the contents decided. In this case, in particular, “A” has transmitted the document to “B”, and hence, “A” transmits the paper document only to “C”. Therefore, even if transmission is possible to the copy machines “B” and “C”, it is necessary to perform setting so as to transmit the document only to “C”.

After all the set items are decided and the “negotiation operation” is finished, the “scan to memory operation” and the “memory to network operation” are sequentially executed, and the paper document read is sent as a digital image to the copy machine 100c. When receiving the digital image, the copy machine 100c performs the “network to memory operation” and the “Memory to Print operation”, and the copy of the paper document obtained by “A” is printed on the paper.

In this manner, “B” and “C” have the paper documents of the same contents as that obtained by “A”. Conversation is continued while they are looking at the paper document, and when the conversation ends, “A”, “B”, and “C” put down their telephone sets, and check out from the copy machine 100a, the copy machine 100b, and the copy machine 100c, respectively.

Another example of the data transmission/reception system (see FIG. 13) including “CTI compatible copy machines” according to the second embodiment is shown below. It is noted that the CTI stands for copier telephony Integration and means that the function is implemented by incorporating between the telephone and the copy machine. The function includes a function of checking telephone records of a user and searching for a copy machine as the other party when image information is transmitted and received through the IP network 50 between the copy machine and another copy machine. The “CTI compatible copy machine” performs “check in/out” operation by the TIFU 17 as shown in the another example.

The data transmission/reception system according to the second embodiment is intended to be a system that effectively functions corresponding to the following situation.

More specifically, assume such a scene that a business person notices that he(she) forgets bringing a material to be distributed to a client on the way to the client. If he goes back to the office to take it with him, he cannot arrive at an appointed place in time. Even in such a case, by executing the following procedure if both a copy machine installed in a convenience store and a copy machine installed in the office support CTI, this case can be solved.

At first, the business person makes a call from his cell phone to the office to tell a staff in the office that he has failed to take the material with him. Then, the staff goes to the place where the material is stored to search for it. The telephone can be disconnected while the staff is searching for the material. In the meantime, the business person goes into a nearby convenience store.

Thereafter, the staff finds out the material, and makes a call to the business person on his (her) cell phone to restart talking. Then, the staff checks in the copy machine in the office and the business person checks in the copy machine in the convenience store. In other words, both the copy machine in the office and the copy machine in the convenience store are “CTI compatible copy machines”, which constitute the data transmission/reception system according to the second embodiment.

When the check-in is complete, they decide on a password during talking on the telephone, and enter the password into the respective copy machines. Thereafter, when the copy machines are ready to communicate with each other, the staff in the office scans the material using the “copy machine-to-copy machine” function, and the copy of the document is output from the copy machine in the convenience store.

The data transmission/reception system according to the second embodiment is intended to be a system that effectively functions corresponding to the following situation.

More specifically, assume such a scene that the CTI compatible copy machine is installed in a call center. The call center indicates a department of a company that deals with inquiries from customers by telephone. Any customer that calls the call center is supposed to have some desire to learn more details of the contents of the products and the services provided by the company. Therefore, when a staff in the call center answers the telephone, the staff is required for explanation sufficient enough for the customer to fully understand. However, since the staff explains only by oral on the telephone, satisfactory information cannot be given to the customer. This results in inadequate responses to the customers in many cases. Consequently, the customer may erroneously interpret the contents or forget the contents, which may lead to some trouble afterwards. Since the quality of the call center largely affects improvement of customer satisfaction (CF), increasing the quality is necessary. If the explanation can be given to the customers not only by oral but also using a drawing and a material, this helps the customers deepen their understanding of the products and the services, which makes it possible to surely deliver the information to the customers.

If the “CTI compatible copy machines” are installed in both the call center and the home of the customer, this problem can be solved in the following manner. At first, the customer calls the call center, and starts talking to the staff on the telephone. Then, the customer checks in the copy machine in the customer's home, and the staff checks in the copy machine in the call center. They decide on a password through the telephone and enter the password into the respective copy machines.

Thereafter, when the copy machines are ready to perform communications, the staff responds to an inquiry from the customer. If transaction of a paper document is necessary during phone inquiry, the sender of a document scans the document using the “copy machine-to-copy machine” function, and the copy of the document is output from the copy machine of the other party.

For example, if there is an inquiry from the customer about an operation of home electronic appliances, the manual can be transferred from the staff to the customer. If there is an inquiry about how to take medicine, the staff can deliver the material including cautions to the customer. Because the customer has the paper document in hand, the contents explained by the staff can be repeated by the customer, thereby reliably delivering the information.

Furthermore, the data transmission/reception system according to the second embodiment is intended to be a system that effectively functions corresponding to the following situation.

More specifically, assume such a scene that a business person is traveling abroad. A scheduled meeting in an appointed place is cancelled on that date, which allows him (her) time to spend one day there. He plans to see the sights of the town where he stays, but he has no travel guidebook or so because this is not expected. Since there are a few bookstores abroad which sell books in Japanese, it is difficult to gain the travel guidebook there.

In such a case, if both a copy machine installed in a hotel where he stays and a copy machine in his home or in a convenience store in his home country (Japan in this case) are the “CTI compatible copy machines”, then the problem can be solved in the following manner.

At first, the business person makes a call from his cell phone to his family at home, and tells his family that he wants tour information for the town where he stays. Then, his family goes to a nearby bookstore to look for a tour guidebook. The telephone may be disconnected while his family is looking for the guidebook.

When finding out and buying the guidebook at the bookstore, his family restarts talking to him on the telephone, to tell him that the guidebook is obtained, and checks in the copy machine in his home or in the convenience store. The business person also checks in a copy machine in the hotel. When the check-in is complete in both sides, they decide on a password through the telephone, and enter the password into the respective copy machines.

Thereafter, when the copy machines are ready to perform communications, his family scans the guidebook using the “copy machine-to-copy machine” function, and the copy of the guidebook is printed out from the copy machine in the hotel where he stays.

As shown in the second embodiment, if the “CTI compatible copy machines” are installed, then the “copy machine-to-copy machine” function works as if it is an application with an expanded telephone function.

This is because when the copy machines 100a to 100c are to be connected to each other through the IP network 50, a copy machine as the other party is automatically found out from the telephone records of the telephone sets 71a to 71c while the users do not need to be conscious of information specific to the copy machines 100a to 100c, being information processing terminals, such as IP addresses and MAC addresses.

Since cell phones are widely used in recent years, even if a user does not know where a person, to whom image data is to be sent, is preset and the user cannot send it to the person, the user contacts him by cell phone, finds out a CTI compatible copy machine, and checks in the CTI compatible copy machine, so that the image information can be transmitted and received between the two.

Although the copy machine connected to the communication network is mainly explained in the embodiments, if a transmission side of image data is a scanner that can acquire image data from a document and a reception side of the image data is a printer that can output the image data, the image data can be transmitted and received.

Although the case where data to be transmitted and received is image data is explained in the embodiments, electronic data to be transmitted and received is not limited to the image data. Therefore, some other data such as moving picture data and speech data may be transmitted and received. The device used for transmitting and receiving the electronic data is not limited to office automation (OA) equipment such as the copy machine, the scanner, and the printer. Home electronic appliances, such as a DVD drive and a monitor connected to a network, may be connected to each other, thereby transmitting and receiving various data.

In the embodiments, the case as follows is explained. That is, a user's telephone number and a called party's telephone number are transmitted from a user's telephone set to a copy machine, and the copy machine transmits its IP address to the server. Thereby, the user's telephone acquires an address of the copy machine used by the other party. However, in addition to this case, the following case may be included. That is, both copy machines may acquire IP addresses of their own machines in the following manner that a user's telephone set acquires an IP address of a copy machine, transmits the user's telephone number and the called party's telephone number together with the IP address acquired to the server. The user's telephone set acquires an IP address of a copy machine used by the other party, and transmits the IP address acquired to the copy machine. In this case, the telephone sets constitute the communication device according to the present invention.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A search device configured to communicate with a first device and a second device through a network, the search device comprising:
a storage unit configured to store therein a first telephone number of the first device, a second telephone number of the second device, and a first communication address of the first device in an associated manner;
a receiving unit configured to receive, from the second device, a third telephone number of the first device, a fourth telephone number of the second device, and a second communication address of the second device;
an extracting unit configured to extract, from the storage unit, a first communication address that corresponds to the third telephone number and the fourth telephone number; and
a transmitting unit configured to transmit extracted first communication address to the second device.

2. A communication device comprising:
a number acquiring unit configured to acquire a telephone number of the communication device and a telephone number of a second communication device to which the communication device is to transmit electronic data through a network; and
an address acquiring unit configured to acquire a communication address of the second communication device based on acquired telephone numbers and a communication address of the communication device.

3. The communication device according to claim 2, further comprising a transmitting unit configured to transmit electronic data to the communication address of the second communication device.

4. The communication device according to claim 3, further comprising:
an authentication-information acquiring unit configured to acquire authentication information that is arbitrarily determined by users;
an authentication-information receiving unit configured to receive authentication information transmitted from the second communication device; and
a determining unit configured to determine whether received authentication information corresponds with acquired authentication information, wherein
the transmitting unit is configured to transmit the electronic data to the second communication device when the determining unit determines that the received authentication information corresponds with the acquired authentication information.

5. The communication device according to claim 4, further comprising a disconnecting unit configured to disconnect communication between the communication device and the second communication device after a specific time has elapsed, when the determining unit determines that the received authentication information corresponds with the acquired authentication information.

6. The communication device according to claim 3, further comprising a target setting unit configured to set a target communication address, when a plurality of communication addresses are acquired by the address acquiring unit, from among the communication addresses, wherein
the transmitting unit is configured to transmit the electronic data to the target communication address.

7. The communication device according to claim 3, further comprising:
a rate setting unit configured to set a charging rate for the communication device and the second communication device when transmission of the electronic data is to be charged; and
a charging unit configured to charge the communication device and the second communication device based on the charging rate.

8. A communication device comprising:
an authentication-information acquiring unit configured to acquire authentication information that is arbitrarily determined by users;
an authentication-information receiving unit configured to receive authentication information transmitted from a second communication device;
a determining unit configured to determine whether received authentication information corresponds with acquired authentication information; and
a transmitting unit configured to transmit electronic data to the second communication device when the determining unit determines that the received authentication information corresponds with the acquired authentication information.

9. The communication device according to claim 8, wherein the transmitting unit is configured not to transmit the electronic data to the second communication device when the determining unit determines that the received authentication information does not correspond with the acquired authentication information.

10. A communication device comprising:
an authentication-information acquiring unit configured to acquire authentication information that is arbitrarily determined by users;
an authentication-information receiving unit configured to receive authentication information transmitted from a second communication device;
a determining unit configured to determine whether received authentication information corresponds with acquired authentication information; and
a disconnecting unit configured to disconnect communication between the communication device and the second communication device after a specific time has elapsed, when the determining unit determines that the received authentication information corresponds with the acquired authentication information.

11. The communication device according to claim 10, further comprising a transmitting unit configured to transmit electronic data to the second communication device when the determining unit determines that the authentication information corresponds with the acquired authentication information.

12. The communication device according to claim 11, the transmitting unit is configured not to transmit the electronic data to the second communication device when the determining unit determines that the received authentication information does not correspond with the acquired authentication information.

13-20. (canceled)
